(19) United States
(12) Patent Application Publication
(10) Pub. No.: US 2024/0010377 A1
(43) Pub. Date: Jan. 11, 2024

(54) MACHINE AND METHOD

(71) Applicant: LOOWATT LTD., London (GB)

(72) Inventors: Adam Paul SYKES, London (GB); Kenneth BEARDSHALL, London (GB); Craig Patrick DOWELL, London (GB)

(21) Appl. No.: 18/026,951

(22) PCT Filed: Sep. 1, 2021
(86) PCT No.: PCT/GB2021/052258

§ 371 Date: Mar. 17, 2023

(30) Foreign Application Priority Data
Sep. 18, 2020 (GB) 2014769.0

(51) Int. Cl. B65B 67/12; B65B 43/46; B65B 43/12; B65H 45/101

(52) U.S. Cl. CPC B65B 67/1277; B65B 43/465; B65B 43/123; B65H 45/101; B65B 2067/1283

(57) ABSTRACT

A machine for packing elongate bags for use with a waste disposal apparatus is disclosed herein. The machine comprises means for holding a reel of flexible tubing, the flexible tubing wound on the reel as a film having two parallel edges, the flexible tubing, when opened, forming a ring of elongate flexible tubing having an aperture at at least one end. The machine also comprises a pair of gripping means configured to engage and grip a region proximate to each edge of the film and draw the film of flexible tubing off of the reel, and a jig configured to be inserted into the aperture and hold a portion of the film in a ring around the jig, the jig configured to hold the film adjacent to and in engagement with the gripping means. Operation of the gripping means causes the film of elongate flexible tubing to be drawn over the jig and to be gathered in a ring of compacted flexible tubing around a base of the jig.

### FIELD OF THE INVENTION

The present application relates to a machine and method for gathering flexible tubing, the flexible tubing for use with a waste disposal apparatus such as a waterless toilet.

### BACKGROUND

Some types of waste disposal apparatus include a replaceable flexible tubing that fits within the apparatus and can be dispensed as necessary. Such waste disposal apparatus includes ‘waterless’ toilets and nappy/diaper disposal units. A waterless toilet is one that does not require water to flush, and can be useful as portable toilets or in regions where water is scarce and/or lacking in suitable infrastructure (for example where traditional sewage treatment facilities are not available). In such toilets, the flexible tubing is folded and stored in a concertina fashion in an annular shape, the annular shape typically corresponding to an open aperture in the top of the toilet. The tubing can be sealed at one end, then can be fed downwards through the toilet housing via, for example rollers, that pinch the edge of the bag. Such a waterless toilet is described, for example, in GB2519820. Recent developments include a toilet that allows for the separation of solid and liquid waste.

The flexible tubing in the toilets needs to be replaced from time to time. However, compacting and packaging the tubing to form refills can be a difficult and complex operation, which adds to the cost of production and raises the potential for refills to be packaged incorrectly. Additionally, in the context of the toilet especially, there is a need for improved design, so that the handling of the tubing during its fitting in a toilet, its operation and subsequent removal minimise the possible contact of a user with potentially soiled surfaces of the tubing and toilet.

### SUMMARY OF THE INVENTION

Aspects of the invention are as set out in the independent claims and optional features are set out in the dependent claims. Aspects of the invention may be provided in conjunction with each other and features of one aspect may be applied to other aspects. In a first aspect there is provided a machine for packing elongate bags for use with a waste disposal apparatus;
means for holding a reel of flexible tubing, the flexible tubing wound on the reel as a film having two parallel edges, the flexible tubing, when opened, forming a ring of elongate flexible tubing having an aperture at at least one end;
a pair of gripping means configured to engage and grip a region proximate to each edge of the film and draw the film of flexible tubing off of the reel;
a jig configured to be inserted into the aperture and hold a portion of the film in a ring around the jig, the jig configured to hold the film adjacent to and in engagement with the gripping means;
wherein operation of the gripping means causes the film of elongate flexible tubing to be drawn off of the reel and over the jig, and to be gathered in a ring of compacted flexible tubing around a base of the jig.

The machine may be configured to produce refills for waterless toilets. The refills may be packaged and compressed elongate bags for use in collecting liquid and/or solid waste. The refills may be packaged and/or arranged into a dispenser for use with a waterless toilet. The elongate bags may be formed from an extended tube of film, which has been compressed longitudinally to form a ring of compacted film, having an aperture extending at least partially therethrough, opposing first and second annular surfaces and an outer surface extending circumferentially around the exterior of the ring, connecting the first and second annular surfaces, wherein the outer surface is formed from the film of material. Optionally, one of the two annular surfaces is closed to provide a watertight seal to the flexible tubing such that the flexible tubing is sealed at one of the two annular surfaces and open at the other of the two annular surfaces for receiving and capturing solid and/or liquid waste when used in a waterless toilet.

The sides of the film may have been concertinaed or pleated in the compacting. The aperture, when viewed from above either the first or second annular surface, may have an elongated shape. In other words, the aperture (when viewed in a direction along its length) in the compacted flexible tubing is preferably elongated, e.g. in that it has a length A and a width B, measured in a direction perpendicular to A, and the aspect ratio of A/B is more than 1, e.g. 1.1 or more, e.g. 1.5 or more, e.g. 2 or more, e.g. 2.5 or more, e.g. 2.8 or more, e.g. 3 or more. In an embodiment, the aspect ratio of A/Bis from 1 to 5, optionally from 1.5 to 5, optionally from 1.5 to 4.5, optionally from 2 to 4, optionally about 2.5 to 3.5, optionally about 3.

The flexible tubing preferably comprises a flexible material, such as a material suitable for forming a bag for accepting waste. The flexible tubing is preferably formed from a tube of film, which may be a polymer, for example a plastic, film. The reel may comprise a film of two layers of flexible material coupled to each other along each parallel edge of the reel, that when opened, forms a ring of elongate flexible tubing having an aperture at at least one end. Each edge of the reel may be considered as an edge of the film as wound onto the reel, the edge being in a direction transverse to the longitudinal axis of the reel, such that when the film is pulled or drawn off of the reel in a uniform manner, the edges of the film remain parallel to each other. For example, the flexible tubing may be made from two layers of film, coupled to each other along each parallel edge of each layer. Additionally, or alternatively, the tubing may be made from a continuous cylinder of film that is folded onto itself to form two layers of film when wound onto a reel or roll. It will be understood that the tubing may comprise two, one or even no (for example if the film is continuous) joins along each parallel edge.

The material of the tubing, which may be or comprise a plastic film, is preferably a film having a thickness of 0.5 mm or less, optionally 0.2 mm or less, optionally 0.1 mm or less, optionally 75 μm or less. The material of the tubing, which may be or comprise a plastic film, is preferably a film having a thickness of from 10 μm or more, optionally from μm to 100 μm, optionally from 20 μm to 50 μm, optionally from 20 μm to 40 μm. The film of the tubing may comprise, consist essentially of, or consist of a polymer selected from, for example, polyethylene, polypropylene, polyester, nylon and polyvinyl chloride. In an embodiment, the film of the tubing may comprise, consist essentially of, or consist of a bioplastic. A bioplastic may be a plastic derived from renewable biomass sources, such as a source selected from vegetable fats and oils, starch, such as corn starch or pea starch, and microbiota. In an embodiment, the plastic film may comprise, consist essentially of, or consist of a biodegradable plastic. A biodegradable plastic may be defined as a plastic capable of being decomposed by bacteria or other living organisms. The biodegradable plastic preferably comprises, consists essentially of or consists of a polymer that meets one or both of European standards, EN 13432 or EN 35 14995. In an embodiment, the biodegradable plastic may be a plastic that meets the requirements for anaerobic biodegradability, e.g. as set out in standard tests such as ASTM 05511-02 and ASTM 05526. Such plastics are commercially available. The flexible tubing preferably has low gas permeability. The flexible tubing preferably has the ability to support and/or increase methane production from waste, e.g. faeces, in an anaerobic environment. The flexible tubing may comprise, consist essentially of or consist of a biodegradable plastic selected from polyhydroxyalkanoates (PHAs) such as poly-3-hydroxybutyrate, polyhydroxyvalerate (PHV), polyhydroxyhexanoate (PHH), polylactic acid (PLA), polybutylene succinate (PBS), polycaprolactone (PCL), polyanhydrides, polyvinyl alcohol, starch-derived plastics, cellulose esters such as cellulose acetate and nitrocellulose. The flexible tubing may comprise the same material as or a different material from the outer flexible web. It will be understood, however, that the flexible tubing is not limited to the above materials. The flexible tubing may be made from compostable plastics, such as plastics that are compostable at home and/or municipally. The flexible tubing and/or the outer flexible web may be transparent.

The reel may comprise a plurality of elongate bags coupled to each other end-to-end in the form of a film on the reel. The elongate bags may be made from a continuous hoop or ring of material folded such that each bag comprises two layers of film coupled to each other along each edge of the film, but when opened, forms a continuous ring of elongate flexible tubing having an aperture at at least one end—each layer thereby forming a portion (for example a semi-circular portion) of the continuous ring of material when opened.

Preferably, the reel comprises a roll of 480 mm or 555 mm film (480 mm or 555 mm being the width of the film on the reel). The roll, may for example, be 10 KG. The film may comprise perforations and/or heat seals at selected intervals, such as at 5 m and/or 3 m and/or 2 m intervals. The perforations and/or heat seals may separate the end of one bag from the start of another on the reel. The perforations and/or heat seals may be in an orientation perpendicular to the edges of the reel such that the perforations and/or seals extend across a width of the film parallel to a longitudinal axis of the reel. In examples where the flexible tubing comprises two layers of film, the heat seals may couple the two layers of film together. The heat seals may be arranged to provide a watertight seal at one end and an adjacent perforation in order to tear off a bag and start the next.

In some examples the pair of gripping means are shaped to provide a complementary shape to the jig. For example, the pair of gripping means may each comprise a portion that has a shape based on that of the jig. For example, the pair of gripping means may each comprise a portion that is shaped to mate with a corresponding portion of the jig. This may help to improve the grip between the gripping means and the film.

In some examples the jig comprises a pair of forming posts, and wherein the pair of gripping means comprises a pair of packing wheels coupled via a driveshaft, each packing wheel comprising a plurality of concave grippers configured to engage and grip each edge of the film against a corresponding one of the forming posts, wherein operation of the gripping means causes the pair of packing wheel to turn in unison in opposite directions to draw the film of elongate flexible tubing to be drawn off of the reel, over the pair of forming posts and to be gathered in a concertinaed and/or pleated ring of compacted flexible tubing around the base of the forming posts. The degree of concavity of each concave gripper may be based on the radius of the two upright forming posts. The radius of curvature of each concave gripper may correspond to the radius of curvature of each of the two upright forming posts.

The spacing of each of the plurality of concave grippers around each of the packing wheels may be configured to fold a portion of the flexible tubing between two grippers to fold the flexible tubing in a concertinaed or pleated fashion. The spacing of each of the plurality of concave grippers around each of the packing wheels may be based on the radius of each of the two upright forming posts.

Each of the pair of forming posts may be configured to bias the film against a corresponding one of the gripping means.

The position of the jig may be adjustable relative to the gripping means to load and/or remove flexible tubing on and/or off of the jig and to engage the film of flexible tubing against the gripping means. Additionally, or alternatively, the position of the gripping means may be adjustable relative to the jig to load and/or remove flexible tubing on and/or off of the jig and to engage the film of flexible tubing against the gripping means.

In some examples the gripping means comprises means for actuation by a user and means for actuation by motor actuation, such as a power drill. For example, the machine may comprise an input for receiving a drive from motor actuation, such as a power drill, the input coupled to the gripping means for actuating the gripping means.

The machine may further comprise a roller, the roller arranged to support and suspend the film of flexible material above the gripping means to feed the film from the reel to the gripping means and onto the jig. In some examples, the means for holding a reel of flexible tubing comprises a spool holder, the spool holder arranged to hold the reel at approximately the same height as the gripping means and below the roller.

In another aspect there is provided a method of packing elongate bags for use with a waste disposal apparatus;
feeding a film of elongate flexible tubing onto a jig, the film of elongate flexible tubing being wound on a reel, the flexible tubing, when opened, forming a ring of elongate flexible tubing having an aperture at at least one end, wherein feeding the film of elongate flexible tubing onto the jig comprises inserting the jig into the aperture such that a portion of the elongate flexible tubing forms a ring around the jig,
engaging a pair of gripping means with a region of the film proximate to each edge of the film;
operating the gripping means to draw the film of flexible tubing off of the reel and over the jig and gather the film in a ring of compacted flexible tubing around a base of the jig.

The jig may comprise a pair of forming posts and the pair of gripping means comprises a pair of packing wheels coupled via a driveshaft, each packing wheel comprising a plurality of concave grippers configured to engage and grip each edge of the film against a corresponding one of the forming posts, wherein operating the gripping means may comprise turning the pair of packing wheel in unison in opposite directions to draw the film of elongate flexible tubing to be drawn off of the reel, over the pair of forming posts and to be gathered in a concertinaed and/or pleated ring of compacted flexible tubing around the base of the forming posts.

In some examples, the ring of elongate flexible tubing comprises a sealed end at an end of the flexible tubing opposite to the aperture, such that the elongate flexible tubing forms an elongate bag. The method may further comprise:
operating the gripping means until the seal engages the top of both forming posts;
separating the elongate bag from the film on the reel;
securing the concertinaed ring of compacted flexible tubing with a flexible outer web;
removing the secured concertinaed ring of compacted flexible tubing from the machine; and
feeding a new portion of the film onto the forming posts to gather a new concertinaed ring of compacted flexible tubing around the forming posts.

The reel may comprise a plurality of elongate bags in the form of a film on the reel.

The method may further comprise operating the forming posts to bias the film against a corresponding one of the gripping means.

In some examples the method comprises adjusting the position of the jig relative to the gripping means to load and/or remove flexible tubing on and/or off of the jig and to engage the film of flexible tubing against the gripping means. Additionally or alternatively, in some examples the method comprises adjusting the position of the gripping means relative to the jig to load and/or remove flexible tubing on and/or off of the jig and to engage the film of flexible tubing against the gripping means.

The method may further comprise activating the gripping means via motor actuation, such as a power drill.

In some examples the method further comprises feeding the film over a roller, the roller arranged to support and suspend the film of flexible material above the gripping means to feed the film from the reel to the gripping means and onto the jig. In such examples, the method may comprise holding the reel of flexible on a spool holder, the spool holder arranged to hold the reel at approximately the same height as the gripping means and below the roller.

In another aspect there is provided a computer readable non-transitory storage medium comprising a program for a computer configured to cause a processor to operate a machine to perform the method described above.

### DRAWINGS

Embodiments of the disclosure will now be described, by way of example only, with reference to the accompanying drawings, in which:

FIG. 1 shows an example of a dispenser for flexible tubing positioned relative to a waterless toilet;

FIG. 2 shows an example dispenser with a first end of the tubing having been dispensed into a waterless toilet;

FIG. 3 shows a side view of an example machine for packing elongate bags for use with a waste disposal apparatus, for example for packing elongate bags of flexible tubing for use with the dispenser and toilet of FIGS. 1 and 2;

FIG. 4 shows another side view of the example machine of FIG. 3;

FIG. 5A shows a side view of an example gripping means for use with the machine of FIGS. 3 and 4;

FIG. 5B shows another side view of the example gripping means of FIG. 5A;

FIG. 6 shows a side view of another example machine for packing elongate bags for use with a waste disposal apparatus, for example for packing elongate bags of flexible tubing for use with the dispenser and toilet of FIGS. 1 and 2; and

FIG. 7 shows another side view of the example machine of FIG. 6.

### SPECIFIC DESCRIPTION

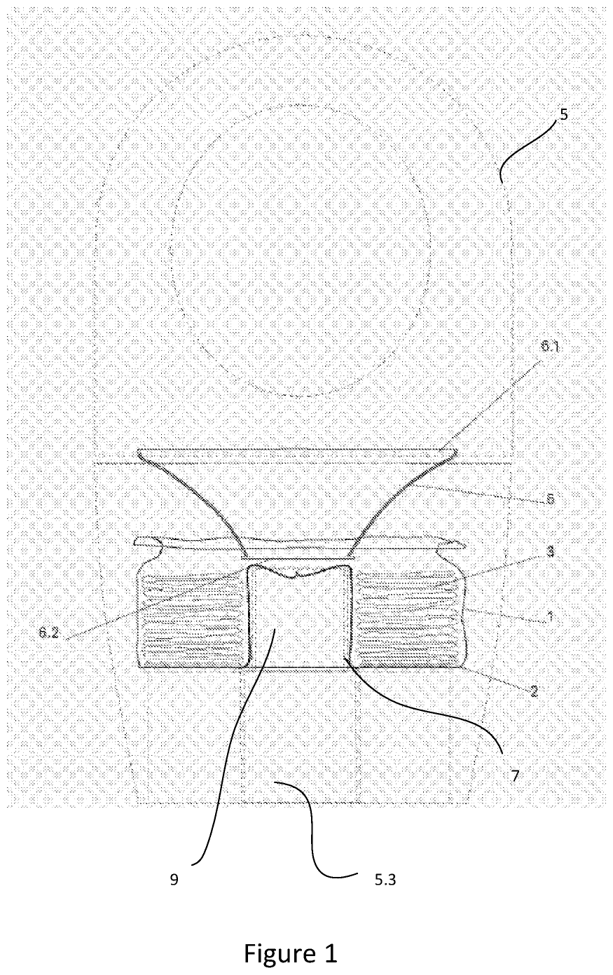

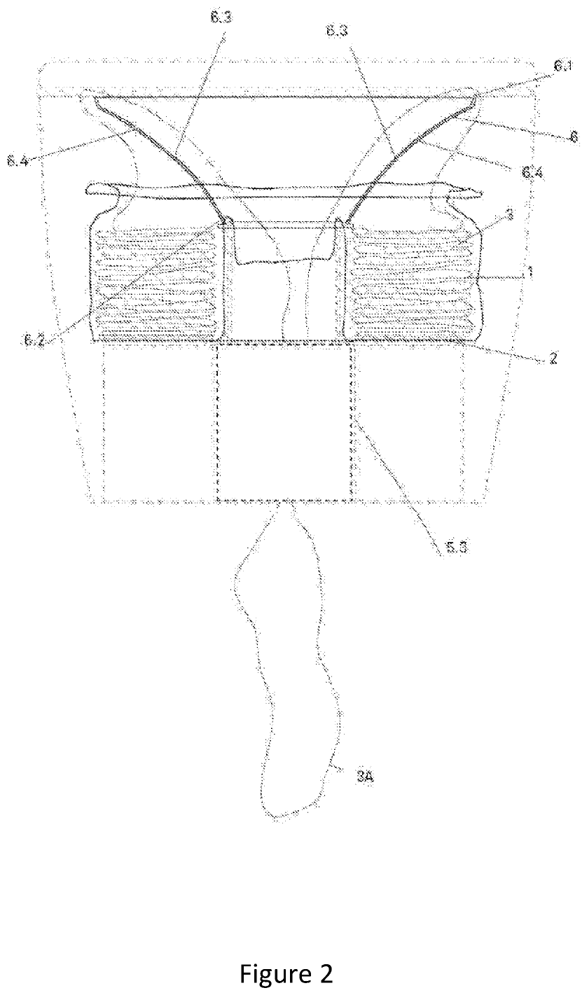

Embodiments of the disclosure relate to a machine and method for gathering flexible tubing, the flexible tubing for use with a waste disposal apparatus such as a waterless toilet. The flexible tubing may be gathered and compacted, for example in a concertinaed or pleated fashion, to make refills for use with the waterless toilets. The refills may be provided as part of a dispenser that can be loaded into or out of the waterless toilet in use. An example of such a dispenser containing a refill of compacted flexible tubing is shown in FIGS. 1 and 2.

FIG. 1 shows a dispenser of flexible tubing 3 for use with a waterless toilet having been fitted to a toilet 5. The dispenser 1 is loaded onto a holder 2 and comprises a flexible web of material forming an outer packaging that contains a stack of compacted flexible tubing 3. The flexible tubing 1 has been compacted into a concertinaed or pleated fashion. The stack of flexible tubing 3 is arranged to provide a stack of a plurality of elongate bags, where the elongate bags are formed from an extended tube of film, which has been compressed longitudinally to form a ring of compacted film, having an aperture extending at least partially therethrough, opposing first and second annular surfaces and an outer surface extending circumferentially around the exterior of the ring, connecting the first and second annular surfaces.

The toilet 5 shown in FIG. 1 is shown with the lid up and comprises a hollow shaft 9 that extends up into the aperture 7 of the compacted flexible tubing. The hollow shaft 9 has rigid walls, made from, for example a rigid plastic material that allows the packaging to be placed over the shaft, such that the shaft extends up into the aperture formed by the aperture 7 in the ring of compacted flexible tubing and the walls of the web of outer packaging of the dispenser 1 extending into this aperture 7. The shaft 9, when viewed from above, has a size and shape approximately the same as those of the aperture in the compacted flexible tubing, although the dimensions of the shaft may be slightly smaller than the aperture in the outer packaging. The sides of the outer web of the dispenser are disposed between the walls of the hollow shaft 9 and the compacted flexible tubing 3.

The toilet 5 comprises a frustoconical member 6 having a wide end 6.1 and a narrow end 6.2. The narrow end 6.2 in FIG. 1 is fitted into the aperture 7 of the ring of compacted flexible tubing 3. The toilet 5 further comprises a unit 5.3 (shown in FIG. 2) that draws the flexible tubing down into the interior of the toilet. The unit 5.3 may act to seal the tubing laterally as it is drawn down into the interior of the toilet. The unit 5.3 has a casing 5.2 extending around the unit 1.3 and the upper surface of which acts to support the dispenser 1 above. The toilet also has a seat attached to the housing. of the toilet by means of a hinge (not shown). The seat 5.4 is shown in FIG. 1 an upright position.

FIG. 2 shows an example dispenser with a first end 3A of the tubing having been dispensed, passed over the outer sides 6.4 of the frustroconical member 6, over the wide end 6.1 of the frustroconical member, down its inner sides 6.3, and through the aperture 7 of the compacted tubing 3, and the corresponding aperture of the hollow shaft 9 below, into the housing of the toilet below the unit 5.3. After being passed over the outer sides 6.4 of the frustroconical member 6, and before being passed down the inner sides of this member, the end 3A of the tubing is sealed, e.g. by being tied. In an alternative embodiment, the end 3A may be passed in an unsealed form down passed 35 the inner sides of the frustroconical member, through the aperture of the compacted tubing and the hollow shaft into the unit 5.3, which may act to seal the end 3A to prevent waste exiting from end 3A. The unit 5.3 may act to draw down the flexible tubing after each use of the toilet. Additionally, or alternatively, the flexible tubing 3 may already be pre-sealed in the dispenser 1 (for example via a heat seal), such that the dispenser 1 comprises a plurality of elongate bags ready for use with the toilet 5. The toilet 5 shown in FIG. 2 is shown with the lid down.

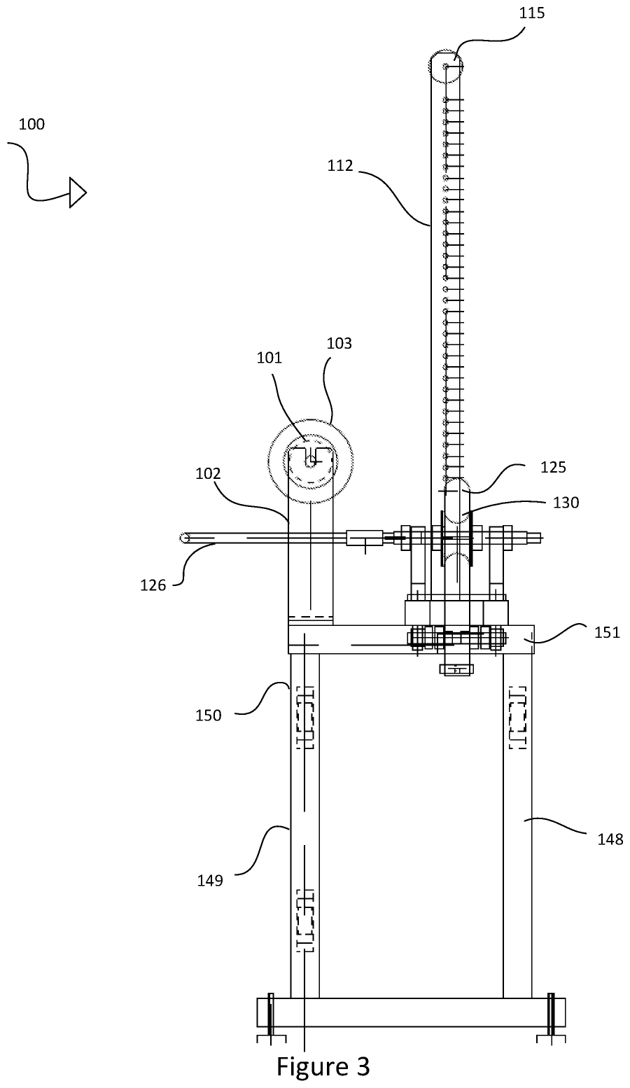

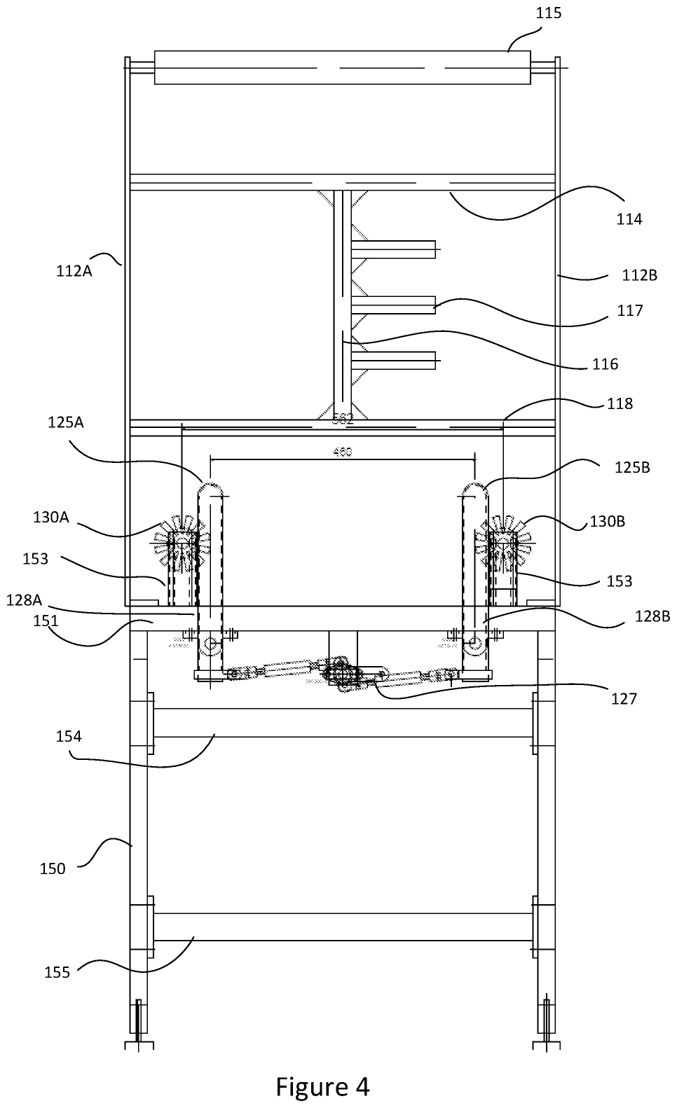

FIGS. 3 and 4 show respective side views of an example machine 100 for packing elongate bags for use with a waste disposal apparatus, for example for packing elongate bags of flexible tubing for use with the dispenser 1 and toilet 5 of FIGS. 1 and 2.

The machine 100 shown in FIGS. 3 and 4 comprises a frame 150 supporting means 101 for holding a reel 103 of flexible tubing, a roller 115, a pair of gripping means 130A, 130B and a jig 125. In the example shown the frame is made from aluminium, but other materials may of course be used. The frame 150 comprises a pair of lower rear upright supports 149A, 149B and a pair lower front upright supports 148A, 148B. A pair of lower cross-bracing members 154, 155 located below the jig 125 and gripping means 130A, 130B couples the pair of lower front upright supports 148A, 148B. A work surface 151 also extends in a horizontal orientation across the top of the lower front upright supports 148A, 148B and the lower rear upright supports 149A, 149B below the jig 125 and gripping means 130A, 130B, such that the lower front upright supports 148A, 148B and the lower rear upright supports 149A, 149B couple to a lower surface of the work surface 151. A pair of upright supports 112A, 112B extend from an upper surface of the work surface 151 supporting a roller 115 at the top thereof. A pair of upright supports 102A, 102B also extend from the upper surface of the work surface 151 to support the supporting means 101 holding the reel 103 in an orientation parallel to the upper surface of the work surface 151.

A pair of upper cross-bracing members 114, 118 couple the pair of upright supports 112A, 112B above the jig 125 and gripping means 130A, 130B but below the roller 115. The cross-bracing members 114, 118, 154, 155 and work surface 151 extend in a horizontal orientation across a width of the machine in a direction parallel to the longitudinal direction of the roller 115 and the reel 113 of flexible tubing when loaded onto the machine 100. Extending in a vertical orientation transverse to and connecting the two upper cross-bracing members 114, 118 is a vertical support 116 and a plurality of horizontal supports 117.

Flexible tubing is wound on the reel 103 as a film having two parallel edges, the flexible tubing, when opened, forming a ring of elongate flexible tubing having an aperture at at least one end. In the example shown the means 101 for holding a reel 103 of flexible tubing comprises a spool holder. In the example shown the spool holder is supported by a spool support 102 that is arranged to hold the reel 103 at approximately the same height as the gripping means 130 and jig 125, and below the roller.

In the example shown, the jig 130 comprises a pair of forming posts 130A, 130B. The pair of forming posts 125A, 125B extend in a generally vertical direction through respective apertures 128A, 128B in the work surface 151 such that they have a base proximate to the work surface 151 and tops that are positioned slightly above each the gripping means, and are separated across a width of the machine by approximately the width of the reel 103. The pair of forming posts 130A, 130B are coupled to each other below the work surface 151 via an actuator 127 at a lower end of each forming post 130A, 130B. In the example shown at the other (upper) end of each forming post 130A, 130B, the forming posts have a rounded end. The rounded end is configured to facilitate insertion into the aperture of the flexible tubing. In the example shown, the actuator 127 is a user-operated lever that is configured to move the lower end of each forming post 130A, 130B either closer together or further apart. The forming posts 130A, 130B are each coupled to a respective pivot, which in the example shown is coupled to an underside of the work surface 151 proximate to and in line with the centre of the apertures 128A, 128B in the work surface 151, although it will be understood that the pivots may be located above or below (or inside) the work surface 151.

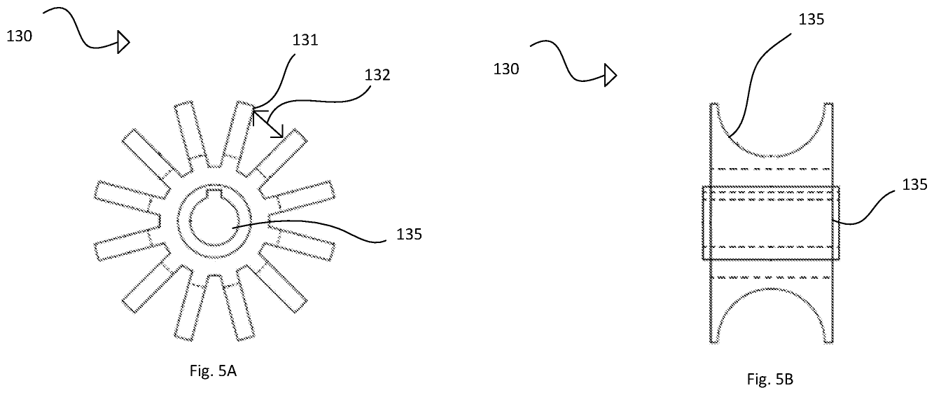

In the example shown the pair of gripping means 125 comprises a pair of packing wheels 125A, 125B coupled via a flexible driveshaft 126, each packing wheel 125A, 125B comprising a plurality of concave grippers 131. The packing wheels 125A, 125B are shown in more detail in FIGS. 5A and 5B, as described in more detail below. The packing wheels 125A, 125B are separated across the width of the machine by approximately the width of the reel 103.

The pair of gripping 125 means comprises means for actuation by a user and means for actuation by a motor actuation, such as a power drill. In the example shown, one of the packing wheels 125B comprises a handle for actuation by a user, and the other one of the packing wheels 125A comprises an input for receiving a drive from a power drill, the input coupled to the gripping means for actuating the gripping means. Because the packing wheels 125A, 125B are coupled together by the flexible driveshaft 126, operation of one of the means for actuation will operate both packing wheels 125A, 125B in unison.

The machine 100 is arranged so that film can fed from the reel 103 over the roller 115 which is arranged to support and suspend the film of flexible material above the gripping means 130A, 130B to feed the film from the reel 103 to the gripping means 130A, 130B and onto the jig 125A, 125B.

The flexible tubing may be the flexible tubing described above with reference to FIGS. 1 and 2, and is preferably formed from a tube of film, which may be a polymer, for example a plastic, film. The reel may comprise a film of two layers of flexible material coupled to each other along each parallel edge of the reel, that when opened, forms a ring of elongate flexible tubing having an aperture at at least one end. Each edge of the reel may be considered as an edge of the film as wound onto the reel, the edge being in a direction transverse to the longitudinal axis of the reel, such that when the film is pulled or drawn off of the reel in a uniform manner, the edges of the film remain parallel to each other.

The jig 130A, 130B is configured to be inserted into the aperture of the flexible tubing to hold a portion of the film in a ring around the jig 130A, 130B. The jig 130A, 130B is configured to hold the film adjacent to and in engagement with the gripping means 125A, 125B. In the example shown, the machine is arranged such that actuation of the actuator 127 causes each of the pair of forming posts 125A, 125B to bias the film against a corresponding one of the packing wheels 125A, 125B. The position of the forming posts 125A, 125B is adjustable relative to the gripping means by operation of the actuator 127 to load and/or remove flexible tubing on and/or off of the forming posts 125A, 125B and to engage the film of flexible tubing against the packing wheels 130A, 130B. In the example shown, because the forming posts 130A, 130B are each coupled to a pivot at the apertures 128A, 128B in the work surface 151, movement of the forming posts 130A, 130B in a first direction underneath the work surface 151 by actuator 127 results in movement of the forming posts in an opposite direction above the work surface 151. Thus, the forming posts 130A, 130B can move by pivoting about the respective pivots in each aperture 128A, 128B, from a retracted configuration distal to the gripping means 125, to a loaded configuration adjacent to the gripping means 125, by operation of the actuator 127.

The pair of packing wheels 125A, 125B are configured to engage and grip a region proximate to each edge of the film and draw the film of flexible tubing off of the reel 103, over the roller 115 and over the forming posts 130A, 130B. The plurality of concave grippers 131 on each packing wheel 130A, 130B are configured to engage and grip each edge of the film against a corresponding one of the forming posts 125A, 125B.

The vertical support 116 and plurality of horizontal supports 117 are arranged for providing a supporting surface behind the film when in use to mark the flexible tubing when loaded into the machine. For example, the operator of the machine may use the supporting surface provided by the vertical support 116 and plurality of horizontal supports 117 to mark the flexible tubing to provide an indication to a user of the toilet when using the flexible tubing that an elongate bag provided by the flexible tubing is approaching its end and that a new elongate bag may need to be loaded into the toilet.

In use, a reel 103 of flexible tubing is loaded onto the means 101 for holding the reel supported by the spool support 102. An end of the film of flexible tubing is drawn off of the reel, fed over the roller 115 and onto and over the pair of forming posts 125A, 125B, optionally until an end of the film touches or is proximate to the working surface 151. In this arrangement the forming posts 125A, 125B are in a retracted configuration, meaning that they are not engaging the packing wheels 130A, 130B and that the separation between them is reduced. Once the film is fed over the forming posts 125A, 125B the forming posts 125A, 125B are actuated by the actuator 127 to be in the loaded configuration, whereby each of the forming posts 125A, 125B engage a corresponding edge of the film (or a region proximate to the edge of the film) against a corresponding packing wheel 130A, 130B. Once the film is loaded onto the machine 100 in this manner, the packing wheels 130A, 130B are turned to draw the film of flexible tubing off of the reel 103 and over the forming posts 125A, 125B to gather the film in a ring of compacted flexible tubing around the base of the forming posts 125A, 125B on the work surface 151. Operation of the packing wheels 130A, 130B causes the pair of packing wheels 130A, 130B to turn in unison in opposite directions to draw the film of elongate flexible tubing off of the reel 103, over the roller 115, over the pair of forming posts 125A, 125B and to be gathered in a concertinaed or pleated ring of compacted flexible tubing around the base of the forming posts 125A, 125B on the upper surface of the work surface 151.

In some examples, the ring of elongate flexible tubing comprises a sealed end at an end of the flexible tubing opposite to the aperture, such that the elongate flexible tubing forms an elongate bag. In such examples, the method may further comprise operating the pair of packing wheels 130A, 130B until the seal engages the top of both forming posts 125A, 125B; separating the elongate bag from the film on the reel 103 (for example by tearing along a perforation line); optionally securing the concertinaed ring of compacted flexible tubing with a flexible outer web; removing the secured concertinaed ring of compacted flexible tubing from the machine 100; and feeding a new portion of the film onto the forming posts 125A, 125B to gather a new concertinaed ring of compacted flexible tubing around the forming posts 125A, 125B.

FIGS. 5A and 5B show respective side views of the packing wheels 130A, 130B shown in FIGS. 3 and 4. Each packing wheel 130A, 130B is mounted on an axle 135 and comprises a plurality of concave grippers 131. In the example shown each concave gripper 131 comprises an elastomeric polymer material (such as silicone, a silicone-based polymer, butyl styrene, natural rubber, vulcanized rubber) configured to grip a portion of the film of elongate tubing held on the reel 103. However, it will be understood that other materials may be used that provide a sufficient coefficient of friction to engage with and grip the film of elongate flexible tubing. For example, gripping means (or a portion thereof) may comprise a material selected based on the material used for the elongate flexible tubing to provide a desired coefficient of friction or a coefficient of friction within a selected range. While, in the example shown, the entirety of the concave grippers 131 are made from the same material, it will be understood that only a portion of each concave gripper may be made from a material that provides a desired coefficient of friction—for example each concave gripper 131 may comprise an elastomeric polymer portion on a outer portion or region, and a base portion of another supporting material (for example a metal such as aluminium) underneath that supports the elastomeric polymer portion.

The concave grippers 131 are spaced apart around a circumference of each wheel 130A, 130B such that there is an equal spacing or slot 132 between each concave gripper 131. The slot 132 between each concave gripper 131 is configured to trap a portion of the film to initiate a pleat or concertina in the film to encourage the film to pack in a concertinaed or pleated fashion when compacted. The degree of concavity 133 of each concave gripper 131 is based on the radius of the two upright forming posts 125A, 125B, for example such that the radius of curvature of each concave gripper 131 corresponds to the radius of curvature of each of the two upright forming posts 125A, 125B. The spacing or size of slot 132 between each of the plurality of concave grippers 131 around each of the packing wheels 130 is configured to fold a portion of the flexible tubing between two grippers to fold the flexible tubing in a concertinaed or pleated fashion. In some examples, the spacing or slot 132 between each of the plurality of concave grippers 131 around each of the packing wheels 130 is based on the radius of each of the two upright forming posts 125A, 125B. The width of each packing wheel 130A, 130B (in a direction parallel to the axis of rotation) is slightly wider than that of each forming post 125A, 125B.

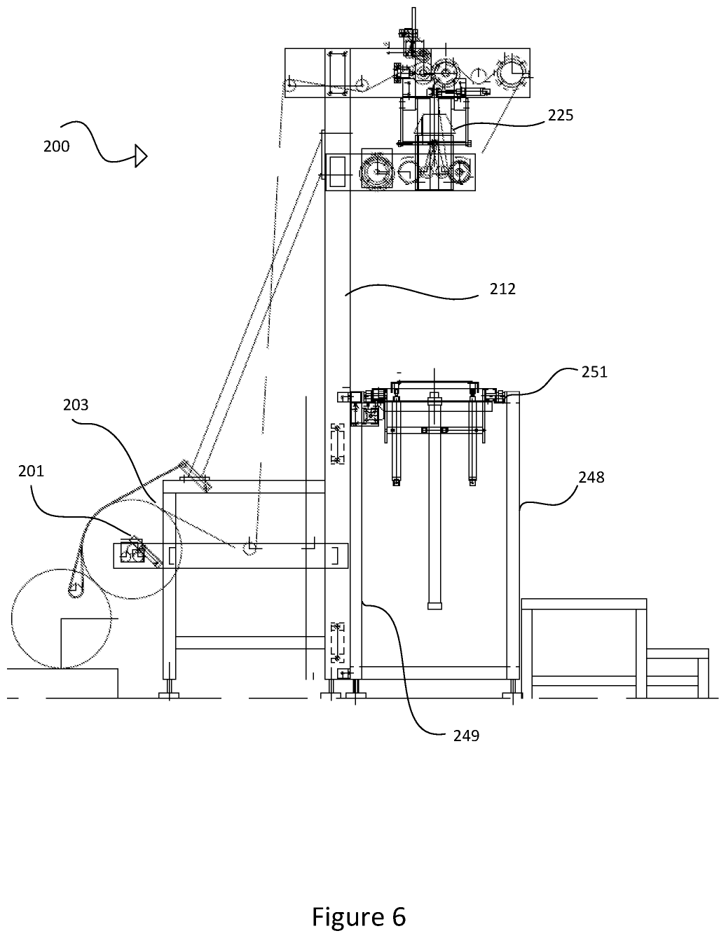

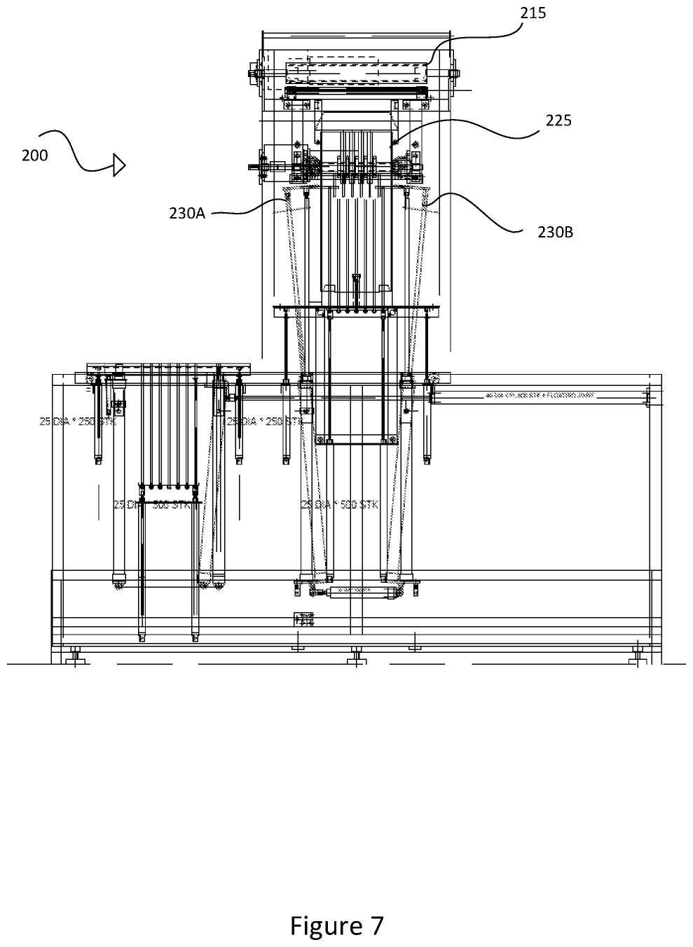

In the example shown, the position of the jig (such as the forming posts 125A, 125B) is adjustable relative to the gripping means (such as the packing wheels 130A, 130B) to load and/or remove flexible tubing on and/or off of the jig and to engage the film of flexible tubing against the gripping means. However, in other examples (such as in the example shown in FIGS. 6 and 7 and as described below in more detail), the position of the gripping means (such as the packing wheels 130A, 130B) is adjustable relative to the jig (such as the forming posts 125A, 125B) to load and/or remove flexible tubing on and/or off of the jig and to engage the film of flexible tubing against the gripping means.

In the example shown, the packing wheels 130A, 130B are shown as having a plurality of concave grippers 131 spaced apart by a slot 132. However, it will be understood that in other examples the concave gripper 131 may be provided by a singular surface without any slots 132. Such a singular surface may also comprise an elastomeric polymer material as described above although it will be understood that other materials may be used that provide a sufficient coefficient of friction to engage with and grip the film of elongate flexible tubing. However, such examples may not as effectively encourage the formation of concertinas or pleats in the film when compressed and packed as examples where there are a plurality of slots 132.

FIGS. 6 and 7 show respective side views of another example machine 200 for packing elongate bags for use with a waste disposal apparatus, for example for packing elongate bags of flexible tubing for use with the dispenser and toilet of FIGS. 1 and 2. Like reference numerals indicate features with the same or similar functionality.

The machine 200 shown in FIGS. 6 and 7 is in many respects very similar to the machine 100 shown in FIGS. 3 and 4. However, in the example shown in FIGS. 6 and 7 the jig comprises a cassette 225 that forms a generally annular or oval shape that is fed into the aperture of the elongate flexible tubing. Once the film is fed onto the cassette 225, a pair of arms 230A, 230B operate to a grip a portion of the film either side of the cassette 225 to grip and pull the film downwards to collect around the base of the cassette 225 on a work surface 251. The arms 230A, 230B may operate in a reciprocating motion whereby they are operated to engage the film against the cassette 225, draw the film down towards the work surface 251 whilst maintaining engagement with the cassette 225, and then releasing the film and retracting in a direction transverse to the direction of draw of the film before moving back up along the cassette 225 and engaging a new portion of the film at a new (higher) region of the cassette 225, whereby the process is repeated. It will be understood that this method of operating the machine to control the arms 230A, 230B and stack and compress the elongate flexible tubing may be provided as part of a computer program.

In more detail, the machine 200 shown in FIGS. 6 and 7 comprises a frame supporting means 201 for holding a reel 203 of flexible tubing, a roller 215, a pair of gripping means 230A, 230B and a jig 225. The frame comprises a pair of lower rear upright supports 249A, 249B and a pair lower front upright supports 248A, 248B. A pair of lower cross-bracing members located below the jig 225 and gripping means 230A, 230B couples the pair of lower front upright supports 248A, 248B. A work surface 251 also extends in a horizontal orientation across the top of the lower front upright supports 248A, 248B and the lower rear upright supports 249A, 249B below the jig 225 and gripping means 230A, 230B, such that the lower front upright supports 248A, 248B and the lower rear upright supports 249A, 249B couple to a lower surface of the work surface 251. A pair of upright supports 212A, 212B extend from an upper surface of the work surface 251 supporting the roller 215 at the top thereof. The frame holds the reel 203 in an orientation parallel to the upper surface of the work surface 251.

Unlike the example of FIGS. 3 and 4, in the example of FIGS. 6 and 7 the jig 225 does not extend through the work surface 251 but instead is held entirely above the work surface 251.

In the example shown in FIGS. 6 and 7 the gripping means 230A, 230B are a pair of arms coupled together below the work surface 251 of the machine. The arms 230A, 230B have end effectors that are shaped to complement and engage with a portion of the cassette 225. The cassette 225 is configured to be only marginally smaller than the size of the aperture in the elongate flexible tubing so that the flexible tubing fits snugly on the cassette 225 which may improve engagement by the gripping means 230A, 230B. In the example shown, the cassette 225 when viewed in cross-section from above is generally annular or oval in shape, with two generally semi-circular shaped regions at either end of a central rectangular region. The end effectors are also generally semi-circular in shape and are configured to engage with a corresponding generally semi-circular shaped portion of the cassette 225. As such, the shape and size of the end effectors is based on the size and shape of at least a portion of the cassette 225. The end effectors may further be coated or covered in a material to improve gripping of the film, for example the end effectors may comprise or be covered in an elastomeric polymer as used with the packing wheels 130A, 130B described above in reference to FIGS. 3 to 5B.

In the context of the present disclosure other examples and variations of the apparatus and methods described herein will be apparent to a person of skill in the art.

1. A machine for packing elongate bags for use with a waste disposal apparatus;
means for holding a reel of flexible tubing, the flexible tubing wound on the reel as a film having two parallel edges, the flexible tubing, when opened, forming a ring of elongate flexible tubing having an aperture at at least one end;
a pair of gripping means configured to engage and grip a region proximate to each edge of the film and draw the film of flexible tubing off of the reel;
a jig configured to be inserted into the aperture and hold a portion of the film in a ring around the jig, the jig configured to hold the film adjacent to and in engagement with the gripping means;
wherein operation of the gripping means causes the film of elongate flexible tubing to be drawn over the jig and to be gathered in a ring of compacted flexible tubing around a base of the jig.

2. The machine of claim 1 wherein the jig comprises a pair of forming posts, and wherein the pair of gripping means comprises a pair of packing wheels coupled via a driveshaft, each packing wheel comprising a plurality of concave grippers configured to engage and grip each edge of the film against a corresponding one of the forming posts, wherein operation of the gripping means causes the pair of packing wheels to turn in unison in opposite directions to draw the film of elongate flexible tubing to be drawn off of the reel, over the pair of forming posts and to be gathered in a concertinaed ring of compacted flexible tubing around the base of the forming posts.

3. The machine of claim 2 wherein each of the pair of forming posts are configured to bias the film against a corresponding one of the gripping means.

4. The machine of claim 2 or 3 wherein the degree of concavity of each concave gripper is based on the radius of the two upright forming posts.

5. The machine of claim 4 wherein the radius of curvature of each concave gripper corresponds to the radius of curvature of each of the two upright forming posts.

6. The machine of any of claims 2 to 5 wherein the spacing of each of the plurality of concave grippers around each of the packing wheels is configured to fold a portion of the flexible tubing between two grippers to fold the flexible tubing in a concertina fashion.

7. The machine of any of claims 2 to 6 wherein the spacing of each of the plurality of concave grippers around each of the packing wheels is based on the radius of each of the two upright forming posts.

8. The machine of any of the previous claims wherein the position of the jig is adjustable relative to the gripping means to load and/or remove flexible tubing on and/or off of the jig and to engage the film of flexible tubing against the gripping means.

9. The machine of any of the previous claims wherein the position of the gripping means is adjustable relative to the jig to load and/or remove flexible tubing on and/or off of the jig and to engage the film of flexible tubing against the gripping means.

10. The machine of any of the previous claims wherein the gripping means comprises means for actuation by a user and means for actuation by motor actuation.

11. The machine of any of claims 1 to 9 further comprising an input for receiving a drive from a motor actuation, the input coupled to the gripping means for actuating the gripping means.

12. The machine of any of the previous claims further comprising a roller, the roller arranged to support and suspend the film of flexible material above the gripping means feed the film from the reel to the gripping means and onto the jig.

13. The machine of claim 12 wherein the means for holding a reel of flexible tubing comprises a spool holder, the spool holder arranged to hold the reel at approximately the same height as the gripping means and below the roller.

14. A method of packing elongate bags for use with a waste disposal apparatus;
feeding a film of elongate flexible tubing onto a jig, the film of elongate flexible tubing being wound on a reel, the flexible tubing, when opened, forming a ring of elongate flexible tubing having an aperture at at least one end, wherein feeding the film of elongate flexible tubing onto the jig comprises inserting the jig into the aperture such that a portion of the elongate flexible tubing forms a ring around the jig,
engaging a pair of gripping means with a region of the film proximate to each edge of the film;
operating the gripping means to draw the film of flexible tubing over the jig and gather the film in a ring of compacted flexible tubing around a base of the jig.

15. The method of claim 14 wherein the jig comprises a pair of forming posts and the pair of gripping means comprises a pair of packing wheels coupled via a driveshaft, each packing wheel comprising a plurality of concave grippers configured to engage and grip each edge of the film against a corresponding one of the forming posts, wherein operating the gripping means comprises turning the pair of packing wheel in unison in opposite directions to draw the film of elongate flexible tubing to be drawn off of the reel, over the pair of forming posts and to be gathered in a concertinaed ring of compacted flexible tubing around the base of the forming posts.

16. The method of claim 15 wherein the ring of elongate flexible tubing comprises a sealed end at an end of the flexible tubing opposite to the aperture, such that the elongate flexible tubing forms an elongate bag, the method further comprising:
operating the gripping means until the seal engages the top of both forming posts;
separating the elongate bag from the film on the reel;
securing the concertinaed ring of compacted flexible tubing with a flexible outer web;
removing the secured concertinaed ring of compacted flexible tubing from the machine; and
feeding a new portion of the film onto the forming posts to gather a new concertinaed ring of compacted flexible tubing around the forming posts.

17. The method of claim 16 wherein the reel comprises a plurality of elongate bags in the form of a film on the reel.

18. The method of any of claims 15 to 17 comprising operating the forming posts to bias the film against a corresponding one of the gripping means.

19. The method of any of claims 14 to 18 comprising adjusting the position of the jig relative to the gripping means to load and/or remove flexible tubing on and/or off of the jig and to engage the film of flexible tubing against the gripping means.

20. The method of any of claims 14 to 19 comprising adjusting the position of the gripping means relative to the jig to load and/or remove flexible tubing on and/or off of the jig and to engage the film of flexible tubing against the gripping means.

21. The method of any of claims 14 to 20 further comprising activating the gripping means via motor actuation.

22. The method of any of claims 14 to 21 further comprising feeding the film over a roller, the roller arranged to support and suspend the film of flexible material above the gripping means to feed the film from the reel to the gripping means and onto the jig.

23. The method of claim 22 comprising holding the reel of flexible on a spool holder, the spool holder arranged to hold the reel at approximately the same height as the gripping means and below the roller.
